(19) United States
(12) Patent Application Publication
(10) Pub. No.: US 2013/0154291 A1
(43) Pub. Date: Jun. 20, 2013

(54) EXTRACTION DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEI-WEI YU, Shenzhen (CN); JUN-LIANG ZHANG, Shenzhen (CN); QUN HUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/719,425

(22) Filed: Dec. 19, 2012

(30) Foreign Application Priority Data
Dec. 20, 2011 (CN) 201110429351.0

(51) Int. Cl. B25B 7/02

(52) U.S. Cl. CPC B25B 7/02
USPC 294/113

(57) ABSTRACT

An exemplary extraction device includes a telescoping mechanism, a clamping mechanism and a shell receiving the telescoping mechanism and the clamping mechanism. The shell defines an accommodating space and a first receiving space. The first receiving space is shaped to receive a sidewall of a device. The telescoping mechanism moves back and forth in the accommodating space and the clamping mechanism closes and opens as the telescoping mechanism moves back and forth. The extraction device can grip a distal end of an element showing outside the sidewall of the device, the sidewall is inserted into the first receiving space of the extraction device and the telescoping mechanism closes on and grips the available small portion of the element, thereby allowing the element to be withdrawn.

### BACKGROUND

1. Technical Field

The present disclosure relates to extraction devices used to facilitate unloading of modular components from electrical devices such as consumer electronic products, and especially to an extraction device for taking an element such as a tray out from a cavity in a wall of an electrical device.

2. Description of Related Art

Many electrical devices include trays for loading and unloading modular elements. A typical mobile phone has a Subscriber Identity Module (SIM) tray arranged at a side wall of the mobile phone for loading and unloading a SIM card. The SIM tray is movable into and out a housing of the mobile phone, so as to switch between a stowed position and an open position. In one type of mobile phone, when the SIM tray is in the stowed position, the SIM tray can be partly ejected from the housing by operation of a trigger mechanism of the mobile phone. In the ejected position, the SIM tray remains mostly received in the housing, with only a small part of the SIM tray, i.e. an edge portion thereof, protruding out from an outer surface of a side wall of the housing. Then the user needs to grip (pinch) the protruding edge of the SIM tray with his/her thumb and forefinger, in order to pull the SIM tray further out from the housing. However, because of the small size of the protruding edge of the SIM tray, the user's fingers are liable to slip and make the pulling operation inconvenient.

What is needed, therefore, is a means which can overcome the kinds of difficulties described above.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a portable electronic device, wherein the portable electronic device includes a slidable SIM card tray, and showing the tray partly exposed from a sidewall of an enclosure of the portable electronic device.

FIG. 2 is an isometric view of an exemplary embodiment of an extraction device.

FIG. 3 is an exploded view of the extraction device of FIG. 2.

FIG. 4 shows the extraction device of FIG. 2 being used with the portable electronic device of FIG. 1.

FIG. 5 is a side plan view of FIG. 4, but omitting the enclosure of the mobile phone, and showing the tray being gripped by the extraction device.

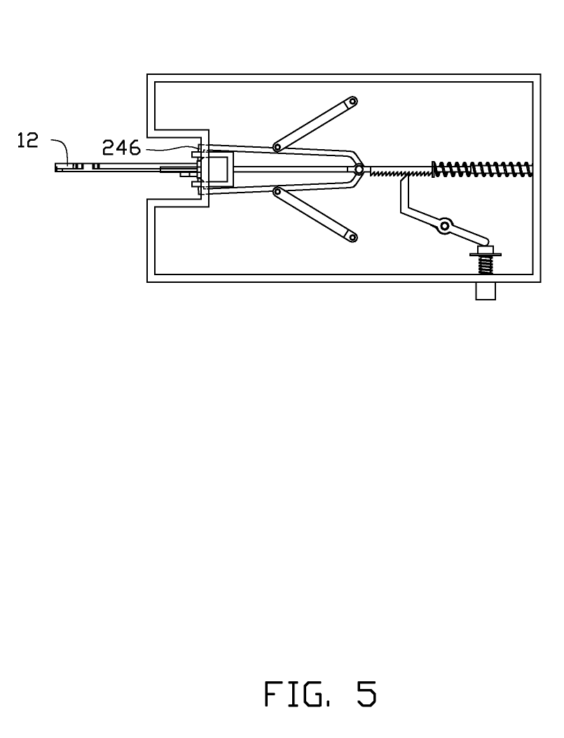

FIG. 6 is similar to FIG. 5, but showing the tray released from the extraction device.

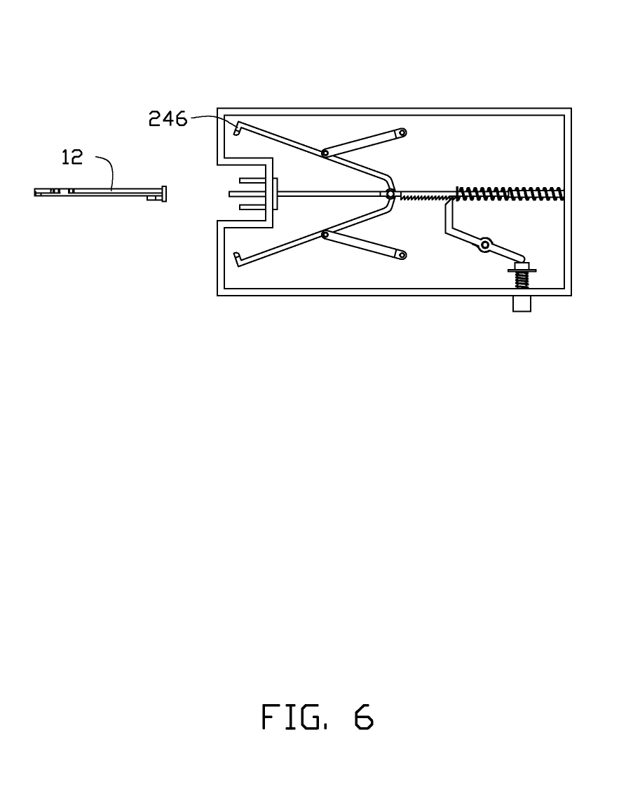

FIG. 7 is similar to FIG. 1, but showing the tray fully exposed from the sidewall.

### DETAILED DESCRIPTION

Reference will be made to the drawings to describe various embodiments.

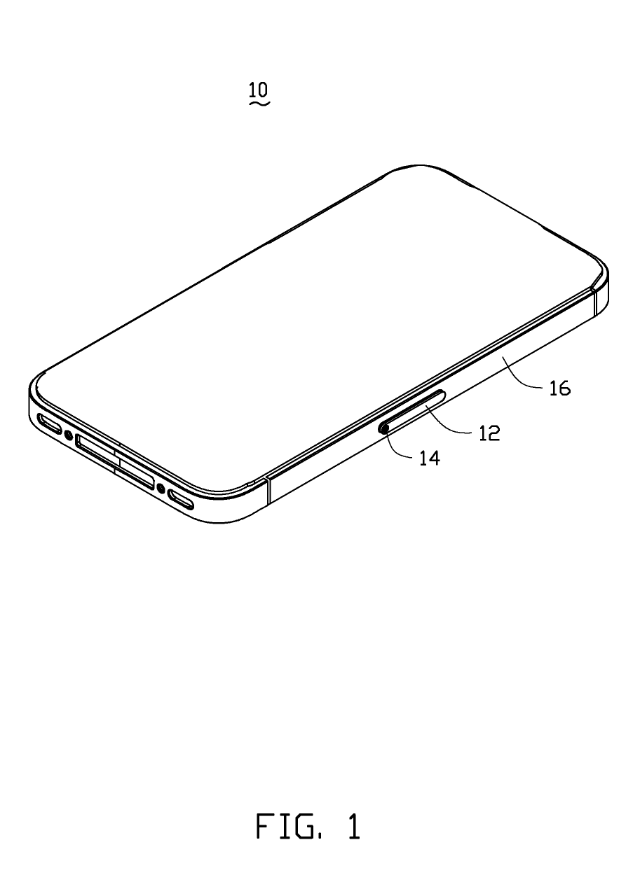

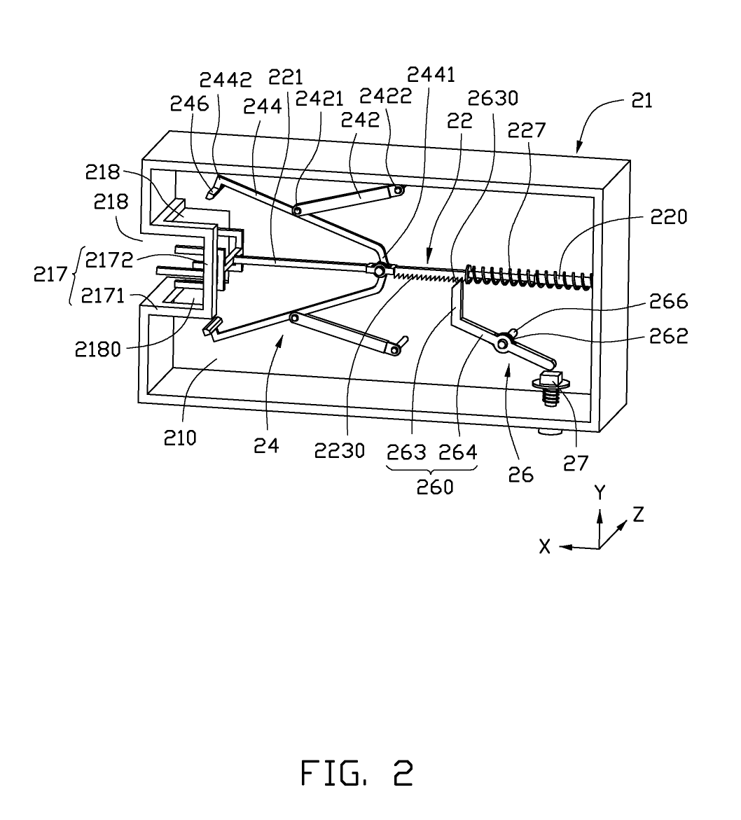

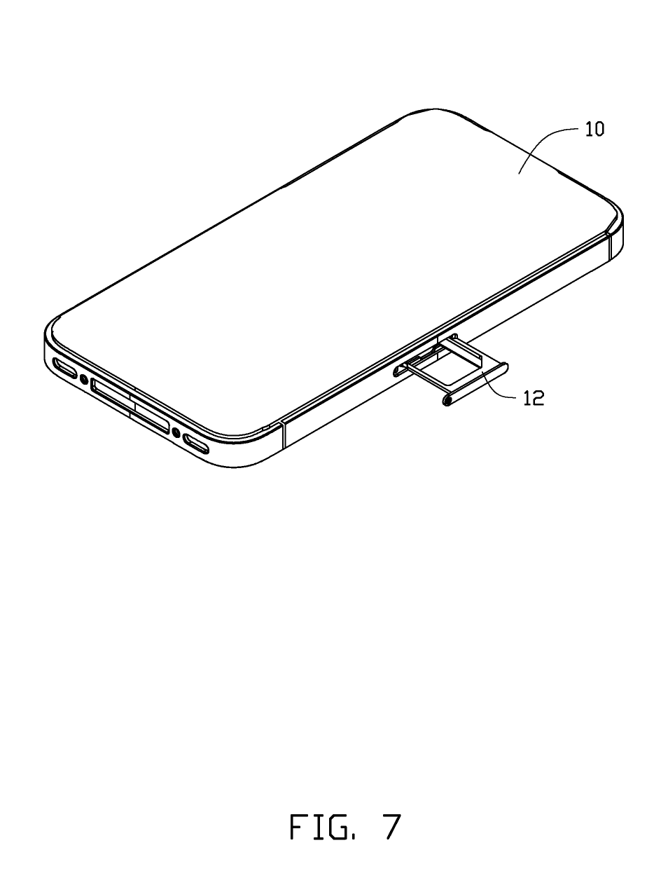

FIG. 1 shows a portable electronic device 10, which includes a slidable tray 12 for holding a card used in the portable electronic device 10. The portable electronic device 10 may be a mobile phone, a personal digital assistant (PDA), or the like, and the card may be a SIM card or a memory card or similar. The tray 12 is slidable out from and into the portable electronic device 10, for loading and/or unloading the card to and/or from the portable electronic device 10. FIG. 2 shows an extraction device 20, which is configured for pulling the tray 12 out from the portable electronic device 10 to a maximum extended position. In this embodiment, the portable electronic device 10 includes an enclosure, and the enclosure includes a sidewall 16 defining an opening (not labeled) therein. The tray 12 is received in the enclosure and is movable into and out of the enclosure, so as to switch between a first position (seen in FIG. 1) and a second (or open) position (seen in FIG. 7).

When the tray 12 is in the first position, the tray 12 is mostly received in the enclosure, and only a distal end of the tray 12 protrudes a slight distance out from the sidewall 16 at the opening. In the present embodiment, the tray 12 is movable from the first position to the second position by the extraction device 20.

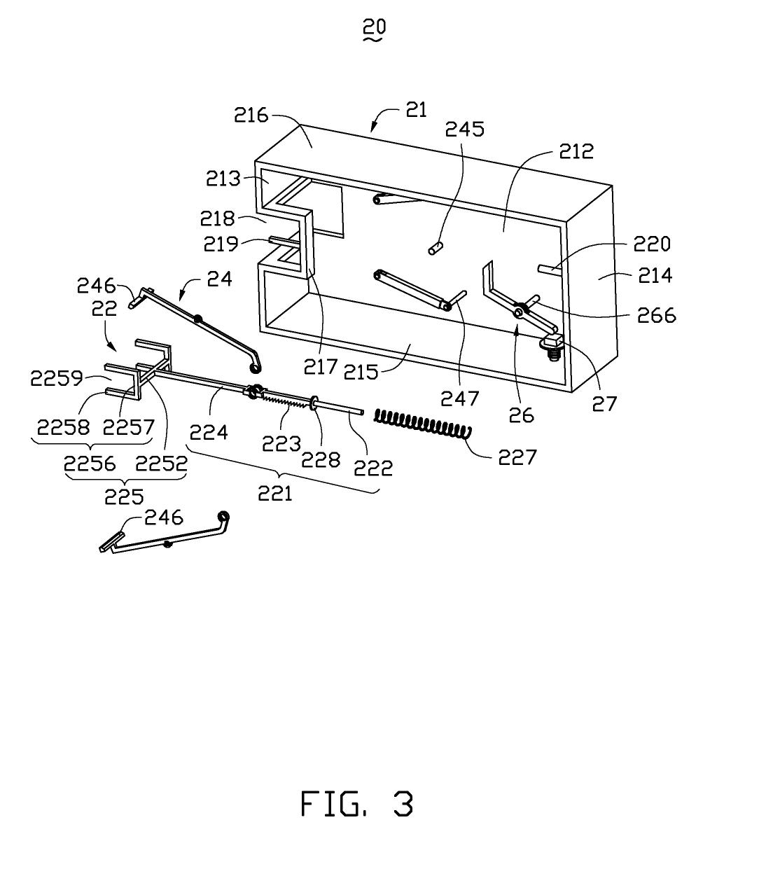

Referring also to FIG. 3, the extraction device 20 includes a shell 21, a telescoping mechanism 22, a clamping mechanism 24, a sway bar mechanism 26 and a pressing button 27. The shell 21 defines an accommodating space 210, and a first receiving space 2180 communicating with the accommodating space 210. The telescoping mechanism 22, the clamping mechanism 24, the sway bar mechanism 26 and the pressing button 27 are substantially received in the accommodating space 210.

In one embodiment, the shell includes a main plate 212, a first sidewall 213, a second sidewall 214 opposite to the first sidewall 213, a third sidewall 215, and a fourth sidewall 216 opposite to the third sidewall 215. The main plate 212 is rectangular. The third and fourth sidewalls 215, 216 perpendicularly extend from two opposite sides of the main plate 212. The first and second sidewalls 213, 214 perpendicularly extend from the other two opposite sides of the main plate 212. The sidewalls 213, 214, 215, 216 and the main plate 212 cooperatively define the accommodating space 210 therebetween. Each of the first sidewall 213 and the main plate 212 defines a cutout 218, and the two cutouts 218 correspond to and communicate with each other. The two cutouts 218 communicate with two sides of the first receiving space 2180, respectively. A shell frame 217 includes two parallel first shell beams 2171 parallel to the fourth sidewall 216, and a second shell beam 2172 perpendicularly interconnecting rear ends of the two first shell beams 2171. The front ends of the two first shell beams 2171 connect to the first sidewall 213 at an edge of the first sidewall 213 furthest from the main plate 212. The shell frame 217 borders a side of the first receiving space 2180 opposite to the side of the first receiving space 2180 communicating with the cutout 218 of the main plate 212. An inserting pole 219 is perpendicularly connected to the second shell beam 2172, and extends toward the cutout 218 of the first sidewall 213.

The telescoping mechanism 22 includes a sleeve 220, an inserting rod 221, and a first elastic member 227. The sleeve 220 is hollow, perpendicularly connected to the second sidewall 214, and extends along a first direction toward the first sidewall 213. The first direction is a direction parallel to an X-axis shown in FIG. 2. A rear end of the sleeve 220 connects to an inner surface of the second sidewall 214. The inserting rod 221 includes a first rod portion 222, a second rod portion 223, a third rod portion 224, a limiting unit 225, and a blocking ring 228. The first, second, and third rod portions 222, 223, 224 extend along the first direction, and the second rod portion 223 interconnects the first and third rod portions 222, 224. The blocking ring 228 is located between the first and second rod portions 222, 223. The second rod portion 223 includes a plurality of teeth 2230 pointing toward the third sidewall 215. The plurality of teeth 2230 serve as a ratchet.

The limiting unit 225 includes a connecting pole 2252 and two limiting frames 2256. Each limiting frame 2256 includes two first limiting beams 2258 extending along the first direction, and a second limiting beam 2257 extending along a second direction which is perpendicular to the first direction and interconnecting the first limiting beams 2258. The second direction is parallel to a Y-axis shown in FIG. 2. The connecting pole 2252 extends along a third direction, which is perpendicular to both the first and second directions. The third direction is parallel to a Z-axis shown in FIG. 2. The second limiting beams 2257 of the two limiting frames 2256 connect to opposite ends of the connecting pole 2252. In addition, a middle of the connecting pole 2252 connects to a distal end of the third rod portion 224. The pair of limiting frames 2256 are at a front side of the connecting pole 2252, and the third rod portion 225 is at a rear side of the connecting pole 2252. The limiting frames 2256 and the connecting pole 2252 cooperatively define a second receiving space 2259 therebetween.

A rear end of the first rod portion 222 is inserted into and limited in the sleeve 220, but is axially movable back and forth inside the sleeve 220. The first elastic member 227 is sleeved on the sleeve 220 and the first rod portion 222, and captive between the blocking ring 228 and the second sidewall 214. The uncompressed length of the first elastic member 227 is longer than a length of the sleeve 220. The first elastic member 227 exerts a resilient force on the blocking ring 228 when compressed.

The clamping mechanism 24 includes two supporting rods 242, two clamping rods 244, and two clamping grippers 246. Each clamping rod 244 includes a first distal end 2441 and a second distal end 2442. Each supporting rod 242 includes a third distal end 2421 and a fourth distal end 2422. The two clamping grippers 246 are connected to the second distal ends 2442 of the two clamping rods 244.

The sway bar mechanism 26 includes a sway bar 260 and a torsion spring 262. The sway bar 260 includes a fourth rod portion 263, and a fifth rod portion 264 connected to the fourth rod portion 263. The fourth rod portion 263 and the fifth rod portion 264 form an obtuse angle therebetween. A free end of the fourth rod portion 263 is in the form of a pawl 2630. The pawl 2630 meshes with any two of the teeth 2230 of the second rod portion 223 of the inserting rod 221. The pressing button 27 is arranged on the third sidewall 215.

In assembly of the extraction device 20, the first elastic member 227 is sleeved on the sleeve 220. The first rod portion 222 is inserted into the sleeve 220, with the rear end of the first rod portion 222 inside the sleeve 220, and the first elastic member 227 sandwiched between the blocking ring 228 and the second sidewall 214. The inserting rod 221 is movable back and forth, thereby retracting further into the sleeve 220 and extending further out from the sleeve 220.

The first distal ends 2441 of the two clamping rods 244 are rotatably attached to the inserting rod 221 at a joint of the second rod portion 223 and the third rod portion 224 via a first spindle 245 which is fixed to the main plate 212 of the shell 21. The two clamping rods 244 are located at opposite top and bottom sides of the inserting rod 221, and the clamping grippers 246 are separated from each other and thus open. Two second spindles 247 are perpendicularly fixed to the main plate 212 at opposite top and bottom sides of the inserting rod 221. The two second spindles 247 are closer to the second sidewall 214 than the first spindle 245. The fourth distal ends 2422 of the two supporting rods 242 are rotatably attached to the two second spindles 247, and the third distal ends 2421 of the two supporting rods 242 are rotatably attached to the two clamping rods 244. A third spindle 266 is perpendicularly fixed to the main plate 212, and the fifth rod portion 264 of the sway bar 260 is rotatably attached to the third spindle 266. The pawl 2630 meshes with two teeth of the teeth 2230 of the second rod portion 223. A free end of the fifth rod portion 264 abuts against a top end of the pressing button 27, whereby a coil spring associated with the pressing button 27 is slightly compressed. Thus, the free end of the fifth rod portion 264 resiliently abuts the pressing button 27.

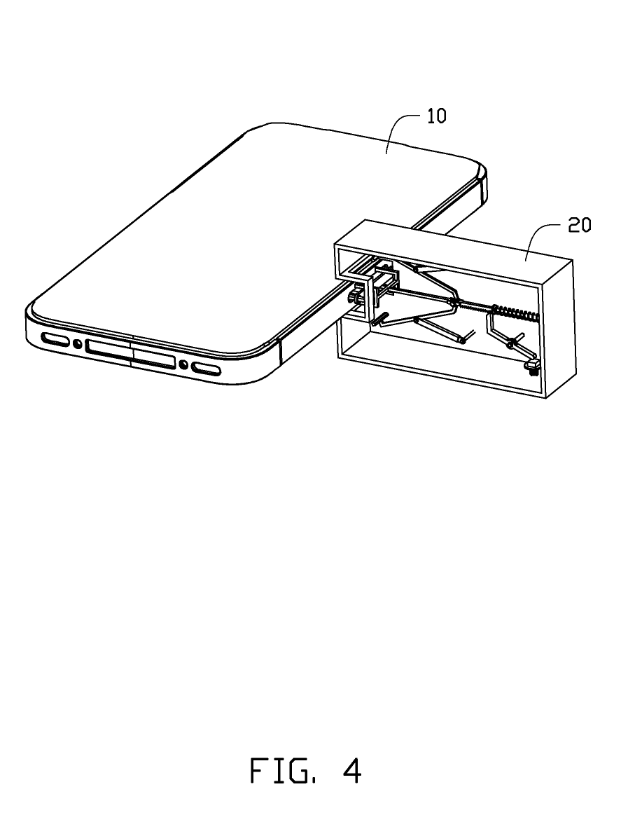

Referring also to FIG. 4, when the extraction device 20 is used, a portion of the sidewall 16 of the portable electronic device 10 is inserted into the first receiving space 2180 of the shell 21 of the extraction device 20. The inserting pole 219 enters a hole 14 of the tray 12, and free ends of the first limiting beams 2258 abut portions of the sidewall 16 surrounding the tray 12. The distal end of the tray 12 protruding out from the sidewall 16 is received in the second receiving space 2259. Then, the user lightly pushes the shell 21 further toward a middle of the portable electronic device 10. As a result, the sidewall 16 drives the first limiting beams 2258 rearward. The inserting rod 221 moves in unison with the first limiting beams 2258 along a rearward direction towards the second sidewall 214. When the inserting rod 221 moves rearward, the second rod portion 223 drives the meshed teeth 2230 rearward, such that the pawl 2630 of the fourth rod portion 263 becomes disengaged from the meshed teeth 2230 of the second rod portion 223 and the sway bar 260 rotates slightly counterclockwise. As a result, the torsion spring 262 exerts resilient force to drive the sway bar 260 to rotate clockwise, so that the pawl 2630 meshes with another two adjacent teeth 2230 of the second rod portion 223. In this way, the pawl 2630 rides over successive teeth 2230 as the second rod portion 223 moves rearward. The first elastic member 227 is compressed when the inserting rod 221 moves rearward.

Because the clamping rods 244 are rotatably attached to the inserting rod 221, and because the supporting rods 242 are rotatably attached to the clamping rods 244, when the inserting rod 221 moves towards the second sidewall 214, the inserting rod 221 drives the supporting rods 242 and the clamping rods 244 to rotate and thus drive the clamping grippers 246 towards each other. The inserting rod 221 moves rearward until the clamping grippers 246 close on and grip the distal end of the tray 12. When the clamping grippers 246 close together, the inserting rod 221 is stopped from moving further rearward, and the user stops pushing the shell 21. At this position, the pawl 2630 of the fourth rod portion 263 is meshed with two teeth 2230 of the second rod portion 223, and the free end of the fifth rod portion 264 resiliently abuts against the top end of the pressing button 27, with the coil spring associated with the pressing button 27 slightly compressed.

The user then pulls the extraction device 20 away from the portable electronic device 10, and thereby the tray 12 is pulled further out from the sidewall 16 of the portable electronic device 10. Once the tray 12 is fully exposed from the sidewall 16 of the portable electronic device 10, the user can disengage the extraction device 20 from the portable electronic device 10, as described below.

To disengage the extraction device 20 from the portable electronic device 10, the user can press the pressing button 27 to separate the clamping grippers 246. In detail, first, the user presses the pressing button 27 downward toward the third sidewall 215, thereby further compressing the coil spring associated with the pressing button 27, and then the user releases the pressing button 27. The coil spring decompresses and drives the pressing button 27 to move upward and strike the free end of the fifth rod portion 264, thereby driving the fifth rod portion 264 to rotate counterclockwise. The pawl 2630 of the fourth rod portion 263 disengages from the teeth 2230 of the second rod portion 223, the inserting rod 221 moves forward toward the first sidewall 213 under urging of the decompressing first elastic member 227, and the clamping grippers 264 are thus fully opened. Thereby, the extraction device 20 is disengaged from the portable electronic device 10 and can be removed from the portable electronic device 10. Then the user can unload a SIM card from the tray 12 and/or load a SIM card onto the tray 12.

Another way the user can disengage the extraction device 20 from the portable electronic device 10 is by exerting force directly on the fifth rod portion 264, to rotate the fifth rod portion 264 counterclockwise and thus open the clamping grippers 264.

In summary, the tray 12 can be readily pulled out to the second position by simply pushing the extraction device 20 onto the portable electronic device 10, pulling the extraction device 20 away from the portable electronic device 10, and then disengaging the extraction device 20 from the portable electronic device 10.

Furthermore, the extraction device 20 can also be used with a variety of other kinds of devices which have slidable elements or bodies, wherein only a small portion of the element or body is accessible for gripping.

It is believed that the present embodiments and their advantages will be understood from the foregoing description, and it will be apparent that various changes may be made thereto without departing from the spirit and scope of the description or sacrificing all of their material advantages, the examples hereinbefore described merely being exemplary embodiments.

What is claimed is:

1. An extraction device, comprising:
a shell defining an accommodating space and a first receiving space, the first receiving space located at a side of the shell and communicating with the accommodating space, the first receiving space configured for receiving a portion of a sidewall of an enclosure of a device;
a telescoping mechanism configured to move back and forth along a first axis in the accommodating space; and
a clamping mechanism comprising two clamping grippers, the clamping mechanism operatively connected to the telescoping mechanism such that the two clamping grippers close toward each other and open away from each other when the telescoping mechanism moves back and forth in the accommodating space;
wherein when an element of the device protrudes out from the portion of the sidewall of the device and the portion of the sidewall of the device is put into the first receiving space, the sidewall abuts the telescoping mechanism and drives the telescoping mechanism to move rearward away from the first receiving space thereby driving the grippers to close, and the grippers clasping the element therebetween for extracting the element from the device.

2. The extraction device of claim 1, wherein the telescoping mechanism comprises an inserting rod extending along the first axis, a sleeve, and a first elastic member, a rear end of the sleeve is perpendicularly connected to the shell at a side opposite to the side where the first receiving space of the shell is defined, the sleeve is hollow and extends along the first axis, the inserting rod comprises a first rod portion, a second rod portion, and a third rod portion, the first rod portion of the inserting rod is inserted into the sleeve, with an rear end of the first rod portion inside the sleeve, and the rear end of the first rod portion is movable back and forth inside the sleeve, such that the inserting rod is movable back and forth along the first axis.

3. The extraction device of claim 2, wherein the second rod portion interconnects the first and second rod portions, a blocking ring locates between the first and second rod portions, the first elastic member is sleeved on the sleeve, and sandwiched between the blocking ring and an inner surface of the shell where the sleeve is connected, the uncompressed length of the first elastic member is longer than a length of the sleeve, and the first elastic member exerts a resilient force on the blocking ring when compressed.

4. The extraction device of claim 3, wherein the shell comprises a main plate, a first sidewall, a second sidewall opposite to the first sidewall, a third sidewall, and a fourth sidewall opposite to the third sidewall, the main plate is rectangular, the first and second sidewalls are perpendicular to the first axis and perpendicularly extend from two opposite sides of the main plate, the third and fourth sidewalls are perpendicular to a second axis and perpendicularly extend from the other two opposite sides of the main plate, the second axis is perpendicular to the first axis, the first, second, third, fourth sidewalls and the main plate define the accommodating space, each of the first sidewall and the main plate defines a cutout, the two cutouts correspond to and communicate with each other, the two cutouts communicate with two sides of the first receiving space, respectively, and the sleeve is connected to the inner surface of the second sidewall.

5. The extraction device of claim 4, wherein the shell comprises a shell frame, the shell frame comprises two parallel first shell beams parallel to the first axis and a second shell beam perpendicularly interconnecting rear ends of the two first shell beams, the front ends of the two first shell beams connect to the first sidewall at an edge of the first sidewall furthest from the main plate, and the shell frame borders a side of the first receiving space opposite to the side of the first receiving space communicating with the cut out of the main plate.

6. The extraction device of claim 5, wherein the clamping mechanism further comprises two clamping rods located at opposite top and bottom sides of the inserting rod and two supporting rods located at opposite top and bottom sides of the inserting rod, each clamping rod comprises a first distal end and a second distal end, each supporting rod comprises a third distal end and a fourth distal end, the two grippers connect to the second distal ends of the clamping rods, the first distal ends of the clamping rods are rotatably attached to the inserting rod at a joint of the second rod portion and the third rod portion via a first spindle which is fixed to the main plate of the shell, the fourth distal ends of the supporting rods are rotatably attached to the two second spindles which are fixed to the main plate at opposite top and bottom sides of the inserting rod, and the third distal ends of the supporting rods are rotatably attached to the two clamping rods, when the inserting rod moves back and forth, the clamping rods rotate to make the grippers close and open.

7. The extraction device of claim 6, wherein the inserting rod further comprises a limiting unit, the limiting unit comprises a connecting pole extending along a third axis perpendicular to the first axis and the second axis and two limiting frames, each limiting frame comprises two first limiting beams extending along the first axis and a second limiting beam extending along the second axis, the second limiting beams of the two limiting frames connect to opposite ends of the connecting pole, a middle of the connecting pole connects to a distal end of the third rod portion, each limiting frame and the third rod portion are located at opposite sides of the connecting pole, the limiting frames and the connecting pole cooperatively define a second receiving space, when a portion of the sidewall of the device is inserted into the first receiving space of the shell, free ends of the first limiting beams abut portions of the sidewall of the device surrounding the element of the device, and the element of the device is received in the second receiving space.

8. The extraction device of claim 6, further comprising a sway bar mechanism, wherein the second rod portion comprises a plurality of teeth pointing toward the third sidewall, the sway bar mechanism comprises a sway bar, a torsion spring, and a pressing button, the sway bar includes a fourth rod portion and a fifth rod portion connected to the fourth rod portion, the fourth rod portion and the fifth rod portion form an obtuse angle therebetween, a free end of the fourth rod portion is in the form of a pawl, the pawl meshes with any two of the teeth of the second rod portion, the fifth rod portion is rotatably attached to a third spindle perpendicularly fixed to the main plate, a free end of the fifth rod portion abuts against a top end of the pressing button, whereby a coil spring associated with the pressing button is slightly compressed.

9. The extraction device of claim 8, wherein when the inserting rod moves rearward toward the second sidewall, the second rod portion drives the meshed teeth of the second rod portion rearward, such that the pawl of the fourth rod portion becomes disengaged from the meshed teeth of the second rod portion and the way bar rotates slightly counterclockwise, after the teeth of the second rod portion and the pawl of the fourth rod portion disengages from each other, the torsion spring exerts resilient force to drive the sway bar to rotate clockwise, the pawl meshes with another two adjacent teeth of the second rod portion, such that the pawl rides over successive teeth as the second rod portion moves rearward until the grippers of the clamping mechanism are closed and clasp the distal end of the element protruding out from the sidewall of the device.

10. The extraction device of claim 9, wherein when the element is pulled out from the sidewall of the device, the pressing button can be pressed to separate the clamping grippers, when the pressing button is pressed downward toward the third sidewall, the coil spring associated with the pressing button is further compressed, and then release the pressing button, the coil spring decompresses and drives the pressing button to move upward and strike the free end of the fifth rod portion, thereby driving the fifth rod portion to rotate counterclockwise, the pawl of the fourth rod portion disengages from the teeth of the second rod portion, the inserting rod moves forward toward the first sidewall under urging of the decompressing first elastic member, and the clamping grippers are thus fully opened.

11. An extraction device for gripping an element of a device located in a first position protruding a slight distance from a sidewall of an enclosure the device and pulling the element out from the first position to a second position in which the element is extended a maximum distance from the sidewall, the extraction device comprising:
a shell defining an accommodating space and a first receiving space, the first receiving space located at a side of the shell and communicating with the accommodating space, the first receiving space configured for receiving a portion of the sidewall of the device;
a telescoping mechanism movable back and forth in the accommodating space along a first axis; and
a clamping mechanism operatively connected to the telescoping mechanism such that the clamping mechanism closes and opens when the telescoping mechanism moves back and forth in the accommodating space;
wherein when the portion of the sidewall of the device where the element located is inserted into the first receiving space, the sidewall abuts the telescoping mechanism and drives the telescoping mechanism to move rearward away from the first receiving space, the clamping mechanism rotates to close and clasps the element located in the first position; and
when the telescoping mechanism is then pulled away from the sidewall of the device, the clamping mechanism correspondingly pulls the element out to the second position.

12. The extraction device of claim 11, wherein the telescoping mechanism comprises an inserting rod extending along the first axis, a sleeve, and a first elastic member, a rear end of the sleeve is perpendicularly connected to the shell at a side opposite to the side where the first receiving space of the shell is defined, the sleeve is hollow and extends along the first axis, the inserting rod comprises a first rod portion, a second rod portion, and a third rod portion, the first rod portion of the inserting rod is inserted into the sleeve, with an rear end of the first rod portion inside the sleeve, and the rear end of the first rod portion is movable back and forth inside the sleeve, such that the inserting rod is movable back and forth along the first axis.

13. The extraction device of claim 12, wherein the second rod portion interconnects the first and second rod portions, a blocking ring locates between the first and second rod portions, the first elastic member is sleeved on the sleeve, and sandwiched between the blocking ring and an inner surface of the shell where the sleeve is connected, the uncompressed length of the first elastic member is longer than a length of the sleeve, and the first elastic member exerts a resilient force on the blocking ring when compressed.

14. The extraction device of claim 13, wherein the shell comprises a main plate, a first sidewall, a second sidewall opposite to the first sidewall, a third sidewall, and a fourth sidewall opposite to the third sidewall, the main plate is rectangular, the first and second sidewalls are perpendicular to the first axis and perpendicularly extend from two opposite sides of the main plate, the third and fourth sidewalls are perpendicular to a second axis and perpendicularly extend from the other two opposite sides of the main plate, the second axis is perpendicular to the first axis, the first, second, third, fourth sidewalls and the main plate define the accommodating space, each of the first sidewall and the main plate defines a cutout, the two cutouts correspond to and communicate with each other, the two cutouts communicate with two sides of the first receiving space, respectively, and the sleeve is connected to the inner surface of the second sidewall.

15. The extraction device of claim 14, wherein the shell comprises a shell frame, the shell frame comprises two parallel first shell beams parallel to the first axis and a second shell beam perpendicularly interconnecting rear ends of the two first shell beams, the front ends of the two first shell beams connect to the first sidewall at an edge of the first sidewall furthest from the main plate, and the shell frame borders a side of the first receiving space opposite to the side of the first receiving space communicating with the cut out of the main plate.

16. The extraction device of claim 15, wherein the clamping mechanism includes two clamping rods located at opposite top and bottom sides of the inserting rod, two supporting rods located at opposite top and bottom sides of the inserting rod, and two grippers, each clamping rod comprises a first distal end and a second distal end, each supporting rod comprises a third distal end and a fourth distal end, the two grippers connect to the second distal ends of the clamping rods, the first distal ends of the clamping rods are rotatably attached to the inserting rod at a joint of the second rod portion and the third rod portion via a first spindle which is fixed to the main plate of the shell, the fourth distal ends of the supporting rods are rotatably attached to the two second spindles which are fixed to the main plate at opposite top and bottom sides of the inserting rod, and the third distal ends of the supporting rods are rotatably attached to the two clamping rods, when the inserting rod moves back and forth, the clamping rods rotate to make the grippers close and open.

17. The extraction device of claim 16, wherein the inserting rod further comprises a limiting unit, the limiting unit comprises a connecting pole extending along a third axis perpendicular to the first axis and the second axis and two limiting frames, each limiting frame comprises two first limiting beams extending along the first axis and a second limiting beam extending along the second axis, the second limiting beams of the two limiting frames connect to opposite ends of the connecting pole, a middle of the connecting pole connects to a distal end of the third rod portion, each limiting frame and the third rod portion are located at opposite sides of the connecting pole, the limiting frames and the connecting pole cooperatively define a second receiving space, when a portion of the sidewall of the device is inserted into the first receiving space of the shell, free ends of the first limiting beams abut portions of the sidewall surrounding the element of the device, and the element of the device is received in the second receiving space.

18. The extraction device of claim 16, further comprising a sway bar mechanism, wherein the second rod portion comprises a plurality of teeth pointing toward the third sidewall, the sway bar mechanism comprises a sway bar, a torsion spring, and a pressing button, the sway bar includes a fourth rod portion and a fifth rod portion connected to the fourth rod portion, the fourth rod portion and the fifth rod portion form an obtuse angle therebetween, a free end of the fourth rod portion is in the form of a pawl, the pawl meshes with any two of the teeth of the second rod portion, the fifth rod portion is rotatably attached to a third spindle perpendicularly fixed to the main plate, a free end of the fifth rod portion abuts against a top end of the pressing button, whereby a coil spring associated with the pressing button is slightly compressed.

19. The extraction device of claim 18, wherein when the inserting rod moves rearward toward the second sidewall, the second rod portion drives the meshed teeth of the second rod portion rearward, such that the pawl of the fourth rod portion becomes disengaged from the meshed teeth of the second rod portion and the way bar rotates slightly counterclockwise, after the teeth of the second rod portion and the pawl of the fourth rod portion disengages from each other, the torsion spring exerts resilient force to drive the sway bar to rotate clockwise, the pawl meshes with another two adjacent teeth of the second rod portion, such that the pawl rides over successive teeth as the second rod portion moves rearward until the grippers of the clamping mechanism are closed and clasp the distal end of the element protruding out from the sidewall of the enclosure of the device.

20. The extraction device of claim 19, wherein when the element is pulled out from the sidewall of the device, the pressing button can be pressed to separate the clamping grippers, when the pressing button is pressed downward toward the third sidewall, the coil spring associated with the pressing button is further compressed, and then release the pressing button, the coil spring decompresses and drives the pressing button to move upward and strike the free end of the fifth rod portion, thereby driving the fifth rod portion to rotate counterclockwise, the pawl of the fourth rod portion disengages from the teeth of the second rod portion, the inserting rod moves forward toward the first sidewall under urging of the decompressing first elastic member, and the clamping grippers are thus fully opened.
